(19) United States
(12) Patent Application Publication
(10) Pub. No.: US 2008/0129963 A1
(43) Pub. Date: Jun. 5, 2008

(54) Animation by selected strobing of rotating images

(76) Inventor: G. Burnell Hohl, New Canaan, CT (US)

Correspondence Address: James F. McLaughlin, Esq.;GRIMES & BATTERSBY, LLP, Third Floor, 488 Main Avenue, Norwalk, CT, 06851, US

(21) Appl. No.: 11/977,838

(22) Filed: Oct. 26, 2007

Related U.S. Application Data
(60) Provisional application No. 60/854,644, filed on Oct. 27, 2006.

(51) Int. Cl. G03B 31/04; G03B 21/50

(52) U.S. Cl. 352/2; 352/92

(57) ABSTRACT

An image animation apparatus having a plurality of translucent images on the wall of a rotating cylinder and a pulsable light source emanating from the cylinder interior. The light source is pulsed in a synchronized manner so that said images are optically aligned in a viewing window in a predetermined order and thereby viewed in such order creating the desired animation effect. An electronic controller receiving cylinder position and velocity information commands the pulsable light source to emit light when the desired imaged has rotated into the viewable position inside the apparatus housing. The cylinder is rotatably driven by a small motor in circular fashion so that each of the images passes by a viewing window. However the viewer only sees the images when the pulsable light source is triggered by the controller. Thus the sequence of images viewed is determined by the controller's programming. Any particular sequence of image motion can be displayed in reverse by simply illuminating the sequence in reverse order.

### CLAIM FOR PRIORITY

This application claims priority to a U.S. Provisional Application No. 60/854,644 entitled “Selected Strobing of Multiple Rotating Images To Create A Virtual Animation Effect” and having a filing date of Oct. 27, 2006 in the USPTO by the same inventor as the non-provisional patent application presented herein.

### BACKGROUND OF THE INVENTION

1. Field of the Invention

The present invention relates generally to the creation of an animation viewing effect using the phenomena of visual persistence. In particular, the invention relates to a mechanism which presents a sequence of translucent still images into a viewing area and selectively backlights particular images with a strobe light in a predetermined order such that the selected images are presented in synchronization with an audio track to create a virtual animation effect.

2. Description of the Prior Art

The use of an apparatus to create animated effects for advertisement, entertainment, or other purposes has long been known. Visual persistence was employed in the late 1800's when the first flip book appeared. The pages of a book each contained a still image and the sequence of the pages when ‘flipped’ created a visual animation to the human eye. Flip books were soon emulated by more sophisticated electro/mechanical devices. For example, U.S. Pat. No. 2,204,435 which issued to Musaphia, on Jun. 11, 1940 for “Animated Display Apparatus” discloses an animated image display device for displaying animated images. Musaphia discloses a rotatable carrier having a figure supported by the carrier, and a light source for illuminating the image.

Various means of image animation, particularly that of facial movement of eyes and mouth exist in the prior art. U.S. Pat. No. 4,104,625 which issued to Bristow et al. on Aug. 1, 1978 discloses an image animation apparatus using a rotating disk with film negatives mounted around its periphery which are selectively flashed by a xenon flash tube, focused by a lens, and projected onto the featureless face of a doll or mannequin.

U.S. Pat. No. 6,647,651 which issued to Cutright on Nov. 18, 2003 for “Animated Theme Shade” shows a translucent shell that carries a series of images and rotates inside an outer lamp shade fitted with viewing slots. Each slot is opened or closed by means of a mechanical shutter that rotates allowing light to pass through the slot while each sequential image is aligned with the slot, thus creating an animation effect.

U.S. Pat. No. 7,080,473 which issued to Kay on Jul. 25, 2006 for “Novelty Animated Device With Synchronized Audio Output, And Method For Achieving Synchronized Audio Output Therein” discloses a lenticular system that animates mouth movement by using several individual printed images which can be rotated so that different images are viewed on a lenticular screen, synchronized with sound. There is need, however, for a simple means of providing sound synchronized animation by strobing individually selected translucent images, transported on a clear rotating cylinder, which yields a more compact, smaller footprint mechanism than a rotating disc, provides improved performance and may be viewed directly without the need for projection through a lens onto a screen.

Older examples of such devices are shown in U.S. Pat. Nos. 3,247,609, 2,795,068, 2,511,394, 2,337,084, 1,921,570 and 1,728,166.

However, there are currently no spinning imagers that offer the unique advantages of the present invention, namely an imager having a strobe light source for selectably displaying a predetermined order of images synchronized with audio output such as music, sound effects or speech.

### SUMMARY OF THE INVENTION

Against the foregoing background, it is a primary object of the present invention to provide an apparatus that displays synchronized audio and video animation in a small portable unit that is completely self-contained.

It is another object of the present invention to provide a low-cost mechanism that animates the facial features and/or body movements of a series of pictures or photographs of a person, animal, or other character.

It is a further object of the present invention to synchronize the movements of the pictures or character's face or body with the playback of audio phrases, songs, or music, so that the character appears to talk, blink its eyes, move or dance in a visually lifelike manner.

It is also an object of the present invention to provide an animation mechanism which is relatively small, compact, lightweight, portable and battery powered.

It is but another object of the present invention to provide an animation mechanism in which the video images and audio tracks may be easily changed.

It is yet another object of the present invention to provide an animation mechanism that is inexpensive to manufacture.

It is but another object of the present invention to provide an animation mechanism that is easy and safe for use with small children.

To the accomplishments of the foregoing objects and advantages, the present invention, in brief summary, comprises an animation apparatus completely self contained in a small portable housing with a viewing window. An internal cylinder having transparent walls with translucent still images mounted thereon is rotated by a small electric motor. As the internal motor drives the cylinder rotationally, images pass by the viewing window. A strobe light controlled by an internal microprocessor receives position information from an indexing means as to the cylinder's exact angular displacement thus allowing the microprocessor to command the strobe light in such a manner as to selectively illuminate any of the images on the cylinder drum in any order desired. The display order can also be reversed without changing the rotational direction of the cylinder by merely illuminating the images in reverse order, thus creating the illusion of ‘rewinding’ or reverse motion. A motion detector can be incorporated in the apparatus so that small children may activate the unit merely by moving it, and the unit may power down and save energy when the child has left the apparatus undisturbed for a period of time. A voice integrated circuit (voice IC) also provides synchronized audio output through a small speaker so as to match speech or other sounds to video character movement.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a perspective side view of the spinning image assembly of the present invention;

FIG. 2 is a side cutaway view of the spinning image assembly of FIG. 1 revealing the strobe assembly;

FIG. 3 is a electronic schematic diagram of the present invention;

### DETAILED DESCRIPTION OF THE PREFERRED EMBODIMENTS

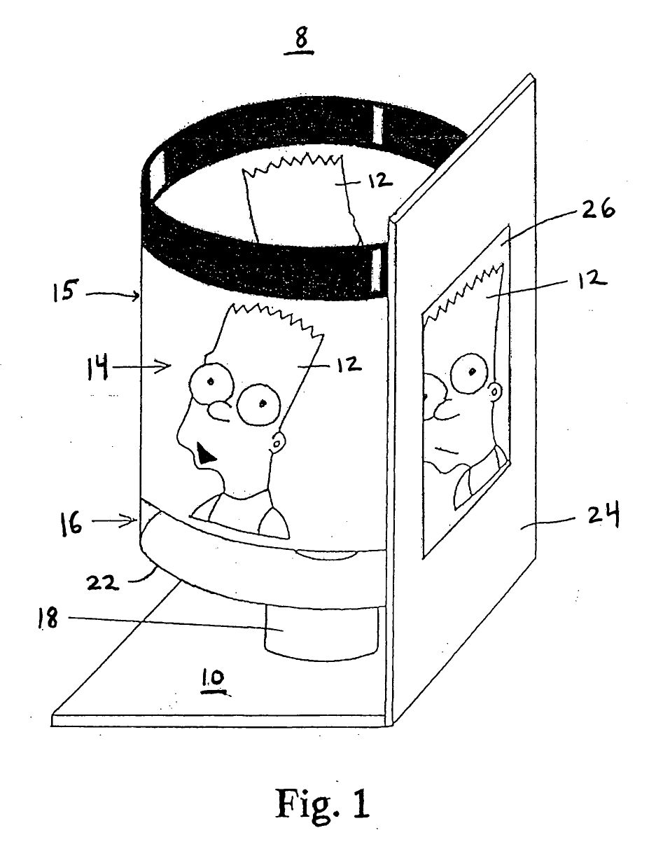

Referring now to the drawings and, in particular, to FIGS. 1-3 thereof, the spinning animator of the present invention is provided and is referred to generally by reference numeral 8. The spinning animator 8 is manufactured in an impact resistant plastic or synthetic housing (not shown) as well known in the art.

Referring now to FIG. 1 a perspective view of the image assembly 10 of the spinning animator 8 is shown. A series of translucent images 12 are first aligned and fixed on a transparent flexible sheet 14, and thereafter are mounted on the drum surface 15 of a clear plastic cylinder 16. In a further embodiment the flexible sheet 14 which carries the images 12 may be colored or may be photographic film, as long as it maintains its translucent quality. The cylinder 16 functions to provide mechanical support and rotatably transport the transparent sheet 14 containing the translucent images 12.

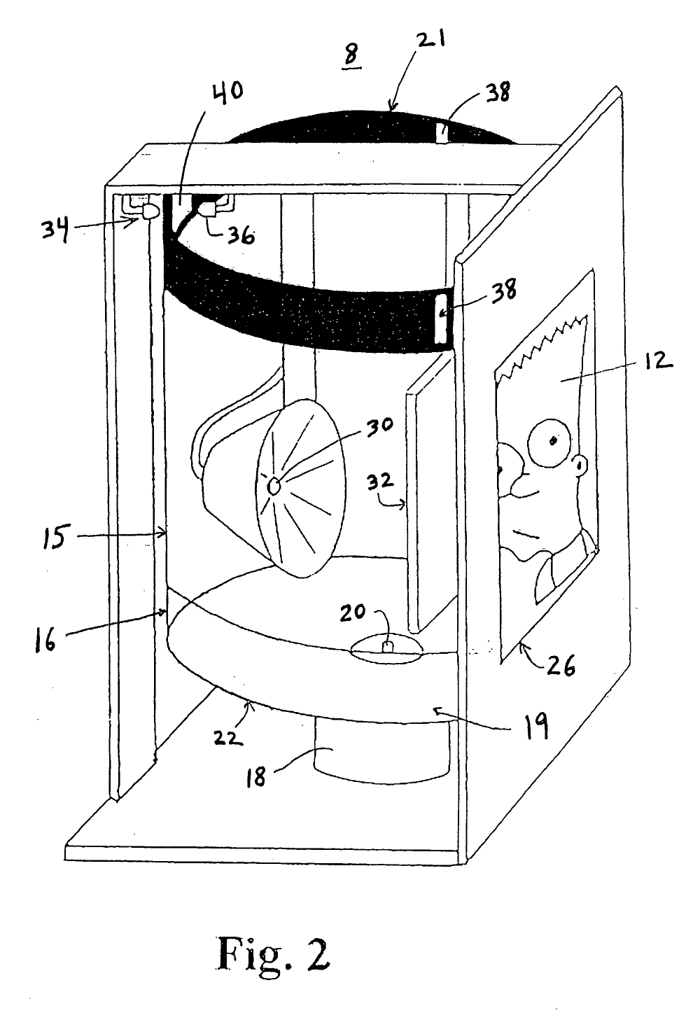

The cylinder 16 is rotated by a low-voltage DC motor 18 whose shaft 20 (see FIG. 2) is fixedly attached to the base 22 of the cylinder 16. The images 12 may be mounted vertically or horizontally on the cylinder 16, and said cylinder 16 may in turn be mounted either horizontally or vertically within a surrounding enclosure 24 (partially shown), depending upon the desired image 12 orientation.

When the images 12 are illuminated as discussed below, they are viewed through a clear window 26 which is usually the same size, or slightly smaller, than that of the images 12 themselves and masks the surrounding internal mechanisms. The image assembly 10 may be enclosed in many different types of housings or enclosures with a flat viewing window 26, as shown in FIG. 1, or with a curved viewing window as, for example, if the image assembly 10 is mounted inside a tube (not shown). It should be noted that a curved viewing window 26 would be designed and shaped so as to match the curvature of the rotating cylinder 16. This would enhance the proximity of the entire image 12 to the viewing surface or window 26.

Depending upon the relative size of the images 12 to the diameter of the cylinder 16, anywhere from a few to many images 12 may be included in the spinning animator 8. To animate the mouth and eyes of a face a minimum of three images 12 are required: i) one showing the mouth closed and eyes open, ii) another showing the mouth open and eyes open, iii) and the third with the mouth closed and eyes closed. Similarly, several images 12 showing a character's body in several different positions may be used to simulate movement such as dancing.

The images 12 are rotated by the motor 18 at approximately forty revolutions per second so that the frame rate for each image 12 is around 25 milliseconds which is fast enough to eliminate flicker in the viewed illuminated image, and due to the phenomena of visual persistence of the human eye, an image 12 strobed at this frame rate appears to be constantly illuminated.

Referring now to FIG. 2, a strobe light 30 and light diffuser panel 32 are shown. Both the strobe light 30 and the diffuser 32 are mounted inside of the transparent cylinder 16. In the preferred embodiment of the invention the strobe light 30 is a white light emitting diode (LED) that is pulsed at least once for each revolution of a selected image 12.

A transmissive or reflective infra-red emitter 34 and photodetector 36 pair detect when a given image 12 is lined up with the viewing window 26 by means of indexing slots 38 or bar codes (not shown) attached to the perimeter at the top 21 or bottom 19 of the cylinder 16, or to the base 22 of the image cylinder 16.

There is a relationship between the duration of the light pulse used to strobe an image 12, the rotational speed of the image cylinder 16, and the size of the cylinder 16. Longer pulses tend to blur the image 12 more due to cylinder transport motion but result in greater illumination of the image 12 due to the larger duty cycle of the strobe lamp 30. In the preferred embodiment of the invention a light pulse of about 100-150 microseconds has been found to be optimal with the images 12 rotating at around forty revolutions per second. Note that strobe lights 30 other than an LED are usable as long as they can be pulsed fast enough, but the speed and low cost of an LED as opposed to a flash tube, for example, is a considerable performance advantage and results in a safer and more commercially viable product as the LED requires no high voltage supply. What is critical in light source selection is the switching times from full off to full illumination and back to full off. The faster the switching times, the more desirable the light source.

It is also possible to use other means of detecting image position such as a visible light sensor, hall-effect sensor, or any other suitable sensory device. In the preferred embodiment of the invention one of the optical index slots 40 is wider than the other slots 38 which denotes the position of the first image 12 and the detection of each successive narrow index slot 38 increments an image counter in the control software.

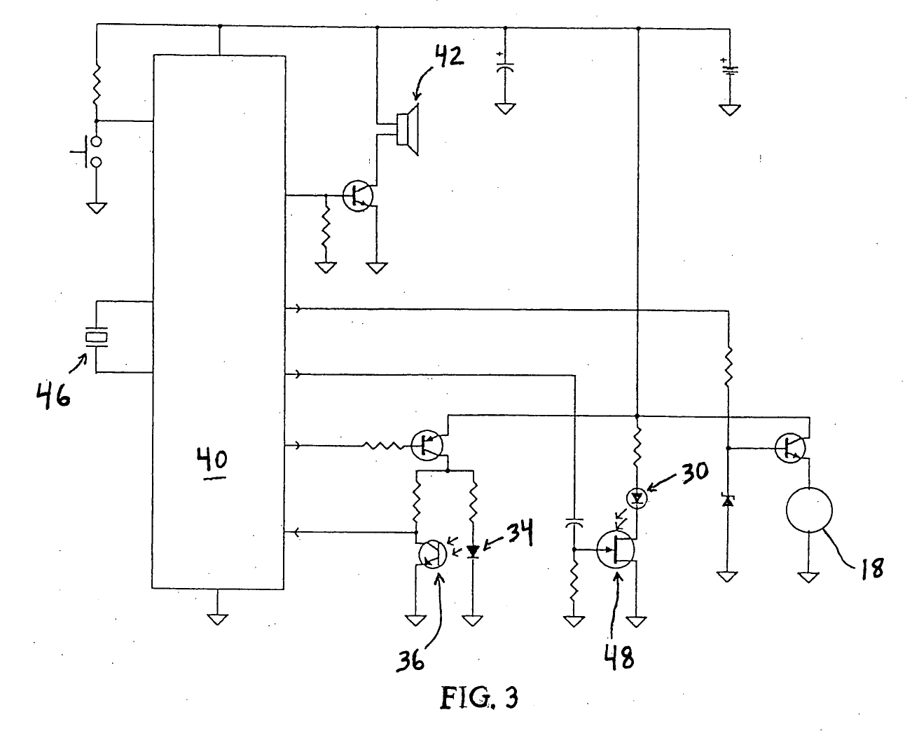

Referring now to FIG. 3, the electronic circuitry used to control and synchronize the spinning animation mechanism 8 is shown. A combination microcontroller/voice integrated circuit hereafter called controller 40 controls the timing and synchronization of audio and visual output through command, control, and or communication with position/velocity sensors, an audio speaker, a motor, and a light source through various input and output ports as well known in the art.

The controller 40 plays one or more audio tracks through a speaker 42 and the controller software program 44 (not shown) implements a series of time delays in its software control program 44 to control the selected strobing of various images 12. The controller 40 uses a stable ceramic resonator or crystal 46 generated timebase combined with a controller 40 internal hardware counter/timer so that the programmed delays stay synchronized with the audio output independent of battery voltage and image rotation speed (battery not shown).

In the preferred embodiment of the invention a battery voltage of 4.5 volts dc to 6 volts dc is used, primarily to provide sufficient electrical capacity to pulse the white LED 30 at sufficient brightness to illuminate the rotating images 12 using a very low duty cycle pulse rate. The LED 30 is strobed with a high current pulse of at least one ampere, using a low power metal oxide semiconductor field effect transistor (MOSFET) 48. A selected image 12 continually is strobed once each revolution of the image cylinder 16 and the controller 40 indexes the images 12 from pulses provided by the photodetector sensor pair 34/36. The software program 44 switches between various images 12 in order to create animation effects such as body or facial movements in synchronization with the audio output as controlled by the stored control program 44 in the controller 40.

It should be obvious to one skilled in the art that other variations of the strobed image animation apparatus 8 are viable. For example, the images 12 can be mounted on a flexible belt or rotating disc, rather than around the surface of a clear cylinder 16, as depicted above. Further, the images 12 may be rotated by means other than a motor 18, including manual rotation. This may be accomplished by spinning a disc manually, or by rotating the image cylinder 16 using a hand crank mechanism, with a gear assembly, so that each revolution of the hand crank yields several rotations of the image cylinder 16 to increase the rotating speed. If the images 12 are to be spun slowly, multiple sets of images 12 may be placed around the image cylinder 16 or disc, so that each individual image 12 is strobed several times per revolution, to reduce the flicker rate for slower rotational speeds. By detecting the rotational speed of the image cylinder, by timing pulse intervals from the optical image indexing sensor, the duration of the LED strobe pulses may be lengthened at slower speeds to maintain constant average light intensity as the rotational speed decreases.

It is also possible to mount the rotating image cylinder 16 behind a lens assembly to project the animated image 12 onto a wall or ceiling. This permits the image 12 to be blown up to a much larger size at the expense of illumination due to the very low strobe duty cycle. In this embodiment, multiple sets of images 12 may be used to increase the projected average light intensity and a high-power LED 30 is used as a light source with a current pulse of several amps to yield a projected image that is sufficiently bright.

Having thus described the invention with particular reference to the preferred embodiments thereof, it will be obvious that various changes and modifications can be made therein without departing from the spirit and scope of the present invention as defined by the appended claims.

Wherefore, I claim:

1. An apparatus for displaying animated images, said apparatus comprising:
a housing having a viewing window;
a rotatable cylinder having a transparent wall;
a plurality of translucent images mounted on said cylinder wall;
a pulsable light source mounted inside said cylinder;
a motor for rotatably driving said cylinder;
a control circuitry for controlling said motor and said light;
wherein said motor drives said cylinder so as to parade said images by said window, and said light is controllably pulsed to illuminate certain selected images in a predetermined sequence to create an animated image that is directly viewable on said cylinder.

2. The apparatus of claim 1, further comprising
a reflector mounted adjacent to said light source and directing said light towards said viewing window;
a light diffuser positioned between said light source and an interior side of said cylinder wall and said viewing window such that an optical path exists from said light source to said viewing window and traverses said diffuser and said selected image;
wherein said reflector causes light from said light source to be directed towards said viewing window and said light is evenly distributed over said selected image causing the viewer to see an evenly illuminated image.

3. The apparatus of claim 2, further comprising:
indexing means providing an angular position information of said cylinder;
said indexing means in communication with said controller;
wherein said controller commands said light source to illuminate said selected images in a predetermined manner as said images pass by said viewing window.

4. The apparatus of claim 3 wherein said indexing means comprises:
a continuous opaque band on said cylinder wall;
at least one slot in said band permitting optical transmission through said band;
an optical emitter/detector pair mounted in opposition from each other on either side of said band;
wherein rotation of said cylinder causes said slot to pass in between said emitter/detector pair, and further said controller in control and communication with said emitter/detector pair senses said passing and thereby determines an angular position of said cylinder.

5. The apparatus of claim 3 wherein said indexing means comprises:
an optical strip with a unique reflective pattern sensitive to infrared or visible energy fixably mounted on said cylinder;
an optical source positioned to illuminating a portion of a travel path of said pattern;
a photodetector mounted to receive said optical illumination reflected from said strip when said strip passes by said optical source;
wherein rotation of said cylinder causes said optical strip to pass through said illumination, and said detector reads said unique pattern, further said controller in control and communication with said detector and thereby determines an angular position of said cylinder.

6. The apparatus of claim 3, further comprising
an audio speaker for providing an audio output, said speaker in communication with said controller;
a software program resident in said controller;
wherein said controller synchronizes said selected images with said audio output.

7. The apparatus of claim 6 wherein said audio output comprises speech synchronized with a series of facial expressions depicted by a series of said selected images.

8. The apparatus of claim 6 wherein said audio output comprises music synchronized with a series of body movements, including dance movements depicted by a series of said selected images.

9. The device of claim 2 further comprising:
a power down software routine resident in said controller whereby said routine senses a power down state and further commands said motor in coordination with indexing information so as to line up a predetermined image with the viewing window so that said image is always visible in the power down state.

10. The device of claim 2 further comprising:
a lens assembly adaptively mounted onto said viewing window wherein said light diffuser is removed and said lens assembly projects and focuses said selected images onto a remote surface such as a wall or ceiling

11. The device of claim 3 further comprising:
means for manual rotation of said cylinder;
said controller in communication with said indexing means so as to determine an instantaneous cylinder position and velocity;
said controller commanding a varying pulse width to said light source so as to provide longer illumination periods at slower cylinder speeds and a shorter illumination period at higher cylinder speeds;
wherein a constant average illumination intensity is provided for said selected image as the cylinder rotational speed varies.
